(19) United States
(12) Patent Application Publication
(10) Pub. No.: US 2010/0276045 A1
(43) Pub. Date: Nov. 4, 2010

(54) EXTENDABLE/RETRACTABLE STUDS FOR A TIRE

(76) Inventors: Andre Cuny, Habav La Neuve (BE); Jean Joseph Collette, Arion (BE); Frank Pierre Severens, Arion (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/432,899

(22) Filed: Apr. 30, 2009

(51) Int. Cl. B60C 11/16

(52) U.S. Cl. 152/210

(57) ABSTRACT

A tire includes a carcass, a tread band having a radially outer tread surface and a plurality of radially extending recesses, and an anti-slip structure disposed in one of the radially extending recesses. The structure includes a cylindrical housing with a cylindrical flange and a central channel and a stud portion with a shaft and a flange. The shaft is slidingly disposed within the central channel such that a radially outer tip of the shaft may selectably extend radially outward from the cylindrical housing and from the radially outer tread surface in order to enhance traction for the tire. The radially outer tip extends from the cylindrical housing and from the radially outer tread surface when a predetermined air pressure is introduced into the radially extending recess thereby forcing the flange of the stud portion radially outward to abut the cylindrical flange of the cylindrical housing.

### FIELD OF THE INVENTION

The present invention relates generally to studs for a tire and, more particularly, to retractable studs for a winter tire.

### BACKGROUND OF THE INVENTION

Since the advent of the powered wheel, man has searched for means to enhance the traction of the wheel with the surface upon which it operates. Early on, the wide steel driving wheels of steam powered traction machinery were equipped with massive steel lugs, which bit into the earth and gave the wheel the traction required to pull a number of breaking or turning plows through the earth. The wide wheels were necessary to provide the area required and support the tractor against sinking into the earth. The lugs provided the grip in the soil required to pull the plows. The coming of the horseless carriage created an entirely new set of problems, as it was nothing more than a motorized adaptation of a horse-drawn vehicle, having free-turning wheels, which were meant to be pulled across the earth, rather than propelled by the powered rotation of the wheels. It was soon discovered that the steel band, or tire, that encircled the wooden wheel rims, was only suitable for use on hard-packed and dry surfaces. From this discovery, there evolved the wider solid rubber and subsequently the pneumatic tire.

Since the evolution of the pneumatic tire, great effort has been dedicated in the search for means to improve the traction of the driving wheels of all manner of vehicles upon the surface and under the conditions which they must operate. Water, mud, and snow are three of the most difficult conditions to address with a modern vehicle tire. Each of these conditions requires a specific tire tread suited either to “channelize” the water away from the tire or grip the soft or slippery surface and either bring more material under the tread area or compact the material to provide a suitably stable driving surface. These conditions however, pale by comparison with the problems encountered when operating a wheeled vehicle on an ice covered surface.

No amount of tread, ribs, bars, and/or other such means are effective upon a surface of solid ice. While time-honored detachable tire chains or cleats provide a measure of traction under these conditions, their use has never been popular due to the difficulty of installation/removal and the bone-shaking ride which they impart to a vehicle employing them.

In an attempt to solve these problems, the conventional “studded tire,” which comprises a tread area which includes a number of hard stud-like projections which extend a short distance beyond the face of the tread to slightly penetrate the surface of the ice and thereby provide a limited mount of traction between tire and iced roadway, was developed. While it appeared that the studded tire would be the definitive solution to the operation of a vehicle on an ice covered surface, such was not the case. Soon after the introduction of studded tires, street and highway officials began to detect rapid deterioration of street and roadway surfaces and called for legislation to restrict or ban their use. Today, in most states and municipalities, the use of the studded tire is controlled by law, ordinance, or regulation requiring that such tires be used only during certain winter months and that such tires be removed from service during the warmer months. Further, some states have enacted legislation which prohibits the use of such tires at any time and have thus deprived motorists of the safety and convenience advantages of such tires.

Another factor which has to some extent lessened the popularity of the studded tire is the fact that the protruding stud reduces, to a certain degree, the ability of the tire to grip a dry roadway with a consequent diminution of braking action. Also, the rotation of the studded tire upon a dry roadway causes an undesirable noise and vibration inside the vehicle. Further, the requirement for removal of studded tires during the warmer months and their re-installation for the winter requires either a second set of wheels for each vehicle or the semi-annual removal and replacement of the tires upon the same wheels with the consequent potential for damage to the “bead” or air sealing area of the tire. Of lesser importance, but still a factor affecting their popularity, is the requirement for storage space for the second set of tires when they are out-of-service.

In the more temperate areas of the nation, the requirement for ice studs is virtually non-existent or may be limited to only a few days a year and quite possibly only for a portion of those days. For example, in the United States, regions south of the 31st parallel, except in the higher elevations, are seldom subject to climatic conditions which produce freezing rain and the consequent coating of ice which makes studded tires desirable. Conversely, the area north of the 36 degree, 30 foot parallel is likely to have ice, snow, or a combination of both on the ground for many days or even weeks of the year. The area between these two parallels may have an ice storm overnight which may result in almost impossible driving conditions during a morning commute, while the evening commute may be made on dry, or nearly dry, roadways.

In order to accommodate the differing requirements of various quickly changing geographical and climatic regions, one conventional tire provides a plurality of retractable traction enhancing elements. This conventional tire has two substantially concentric casings which are selectably inflatable or deflatable to cause the extension or retraction of stud-like anti-skid projections.

Another conventional tire has stud-like projections which may be forced through the tread area of the tire by differential air pressure between the interior of the casing and hoses which pass about the inner periphery of the casing and pass under stud-like projections. Still another conventional tire employs a similar differential air pressure system for extending and retracting studs through the tread area of the tire and further provides an internal reservoir for high pressure actuating air within the casing and a specialized valve for filling the reservoir and extending or retracting the studs.

Yet another conventional tire employs a multi-chambered casing which allows the pneumatic outward flexure of a centrally situated stud-bearing band about the periphery of the tire at the center of the tread band into a road contacting position. Still another conventional tire provides “tire, pressure dependent” traction enhancing studs for use on ice covered roadways. This conventional tire has an operator or driver selectable “on-demand” feature for engaging and disengaging traction enhancing studs.

While these conventional tires may be functional, none have provided wide-spread availability due to manufacturing and cost constraints. Thus, these conventional tires have not been adopted by the tire industry and have thus been relegated to obscurity. A tire that may be employed year-round without causing unnecessary wear to the roadway, yet be instantly available in a studded configuration when required, would be desirable.

### SUMMARY OF INVENTION

A tire in accordance with the present invention includes a carcass, a tread band having a radially outer tread surface and a plurality of radially extending recesses, and an anti-slip structure disposed in one of the radially extending recesses. The structure includes a cylindrical housing with a cylindrical flange and a central channel and a stud portion with a shaft and a flange. The shaft is slidingly disposed within the central channel such that a radially outer tip of the shaft may selectably extend radially outward from the cylindrical housing and from the radially outer tread surface in order to enhance traction for the tire. The radially outer tip extends from the cylindrical housing and from the radially outer tread surface when a predetermined air pressure is introduced into the radially extending recess thereby forcing the flange of the stud portion radially outward to abut the cylindrical flange of the cylindrical housing.

In accordance with another aspect of the present invention, the cylindrical housing of the structure further includes a radially inner surface, an opposite radially outer surface, and a biasing element extending radially inward from the radially inner surface. The biasing element maintains the radially outer tip of the stud portion in an unextended position when air pressure in the radially extending recess is less than the predetermined air pressure.

In accordance with still another aspect of the present invention, the predetermined air pressure is introduced into the radially extending recess by an axially extending channel.

In accordance with yet another aspect of the present invention, the axially extending channel interconnects a radially innermost portion of the radially extending recess and an axially outer side portion of the tread band.

In accordance with still another aspect of the present invention, the cylindrical housing of the structure further includes a radially inner surface, an opposite radially outer surface, and a biasing element extending radially inward from the radially inner surface. The biasing element compresses into a recess at the radially inner surface when the predetermined air pressure is present in the radially extending recess.

In accordance with yet another aspect of the present invention, the tire is a pneumatic tire and the predetermined air pressure is supplied by an inflation pressure of the pneumatic tire.

In accordance with still another aspect of the present invention, the radially outer tip of the stud portion is flush with an outer surface of the cylindrical housing and the radially outer tread surface when air pressure in the radially extending recess is less than the predetermined air pressure.

In accordance with yet another aspect of the present invention, the plurality of radially extending recesses each have a shoulder portion for limiting radially outer movement of the flange of the housing.

In accordance with still another aspect of the present invention, the flange of the housing limits radially outer movement of the flange of the stud portion.

In accordance with yet another aspect of the present invention, a sealing element seals the predetermined air pressure within the radially extending recess.

### DEFINITIONS

The following definitions are controlling for the disclosed invention.

“Apex” refers to a wedge of rubber placed between the carcass and the carcass turnup in the bead area of the tire, usually used to stiffen the lower sidewall of the tire.

“Aspect ratio” of the tire means the ratio of its section height (SH) to its section width (SW) multiplied by 100% for expression as a percentage.

“Annular” means formed like a ring.

“Axial” and “axially” mean lines or directions that are parallel to the axis of rotation of the tire; synonymous with “lateral” and “laterally”.

“Bead” means that part of the tire comprising an annular tensile member wrapped by ply cords and shaped, with or without other reinforcement elements such as flippers, chippers, apexes, toe guards and chafers, to fit the design rim.

“Belt reinforcing structure” means at least two layers of plies of parallel cords, woven or unwoven, underlying the tread, unanchored to the bead, and having both left and right cord angles in the range from 17 degrees to 27 degrees with respect to the equatorial plane of the tire.

“Belt structure” means at least two annular layers or plies of parallel cords, woven or unwoven, underlying the tread, unanchored to the bead, and having both left and right cord angles in the range from 17 degrees to 27 degrees with respect to the equatorial plane of the tire.

“Bias ply tire” means a tire having a carcass with reinforcing cords in the carcass ply extending diagonally across the tire from bead core to bead core at about a 25 degree to 50 degree angle with respect to the equatorial plane (EP) of the tire. Cords run at opposite angles in alternate layers.

“Breakers” refers to at least two annular layers or plies of parallel reinforcement cords having the same angle with reference to the equatorial plane of the tire as the parallel reinforcing cords in carcass plies.

“Buffed” means a procedure whereby the surface of an elastomeric tread or casing is roughened. The roughening removes oxidized material and permits better bonding.

“Building Drum” refers to a cylindrical apparatus on which tire components are placed in the building of a tire. The “Building Drum” may include apparatus for pushing beads onto the drum, turning up the carcass ply ends over the beads, and for expanding the drum for shaping the tire components into a toroidal shape.

“Carcass” means the tire structure apart from the belt structure, tread, undertread, and sidewall rubber over the plies, but including the beads.

“Casing” means the carcass, belt structure, beads, sidewalls, and all other components of the tire including a layer of unvulcanized rubber to facilitate the assembly of the tread, the tread and undertread being excluded. The casing may be new, unvulcanized rubber or previously vulcanized rubber to be fitted with a new tread.

“Center plane” means the plane perpendicular to the axis of rotation of the tread and passing through the axial center of the tread.

“Circumferential” means lines or directions extending along the perimeter of the surface of the annular tire parallel to the equatorial plane (EP) and perpendicular to the axial direction.

“Chafers” refers to narrow strips of material placed around the outside of the bead to protect cord plies from the rim, distribute flexing above the rim, and to seal the tire.

“Chippers” mean a reinforcement structure located in the bead portion of the tire.

“Cord” means one of the reinforcement strands of which the plies in the tire are comprised.

“Design rim” means a rim having a specified configuration and width. For the purposes of this specification, the design rim and design rim width are as specified by the industry standards in effect in the location in which the tire is made. For example, in the United States, the design rims are as specified by the Tire and Rim Association. In Europe, the rims are as specified in the European Tyre and Rim Technical Organisation—Standards Manual and the term design rim means the same as the standard measurement rims. In Japan, the standard organization is The Japan Automobile Tire Manufacturer's Association.

“Design rim width” is the specific commercially available rim width assigned to each tire size and typically is between 75% and 90% of the specific tire's section width.

“Equatorial plane (EP)” means the plane perpendicular to the tire's axis of rotation and passing through the center of its tread.

“Filament” refers to a single yarn.

“Flipper” refers to reinforcing fabric around the bead wire for strength and to tie the bead wire into the tire body.

“Footprint” means the contact patch or area of contact of the tire tread with a flat surface at zero speed and under normal load and pressure.

“Groove” means an elongated void area in a tread that may extend circumferentially or laterally about the tread in a straight, curved, or zigzag manner. Circumferentially and laterally extending grooves sometimes have common portions. The “groove width” is equal to tread surface occupied by a groove or groove portion, the width of which is in question, divided by the length of such groove or groove portion; thus, the groove width is its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves which they interconnect, they are regarded as forming “tie bars” tending to maintain a rib-like character in the tread region involved.

“Inboard side” means the side of the tire nearest the vehicle when the tire is mounted on a wheel and the wheel is mounted on the vehicle.

“Inner” means toward the inside of the tire and “outer” means toward its exterior.

“Lateral” means an axial direction.

“Lateral edge” means the axially outermost edge of the tread as defined by a plane parallel to the equatorial plane and intersecting the outer ends of the axially outermost traction lugs at the radial height of the inner tread surface.

“Leading” refers to a portion or part of the tread that contacts the ground first, with respect to a series of such parts or portions, during rotation of the tire in the direction of travel.

“Net contact area” means the total area of ground contacting tread elements between the lateral edges around the entire circumference of the tread divided by the gross area of the entire tread between the lateral edges.

“Net-to-gross ratio” means the ratio of the tire tread rubber that makes contact with a hard flat surface while in the footprint, divided by the area of the tread in the footprint, including non-contacting portions such as grooves.

“Nominal rim diameter” means the average diameter of the rim flange at the location where the bead portion of the tire seats.

“Normal inflation pressure” refers to the specific design inflation pressure and load assigned by the appropriate standards organization for the service condition for the tire.

“Normal load” refers to the specific design inflation pressure and load assigned by the appropriate standards organization for the service condition for the tire.

“Outboard side” means the side of the tire farthest away from the vehicle when the tire is mounted on a wheel and the wheel is mounted on the vehicle.

“Pantographing” refers to the shifting of the angles of cord reinforcement in a tire when the diameter of the tire changes, e.g. during the expansion of the tire in the mold.

“Ply” means a continuous layer of rubber-coated parallel cords.

“Pneumatic tire” means a laminated mechanical device of generally toroidal shape (usually an open torus) having beads and a tread and made of rubber, chemicals, fabric and steel or other materials. When mounted on the wheel of a motor vehicle, the tire through its tread provides traction and contains the fluid or gaseous matter, usually air, that sustains the vehicle load.

“Radial” and “radially” mean directions radially toward or away from the axis of rotation of the tire.

“Section height” means the radial distance from the nominal rim diameter to the outer diameter of the tire at its equatorial plane.

“Shoulder” means the upper portion of sidewall just below the tread edge. Tread shoulder or shoulder rib means that portion of the tread near the shoulder.

“Tread Width” means the arc length of the tread surface in the axial direction, that is, in a plane parallel to the axis of rotation of the tire.

“Undertread” refers to a layer of rubber placed between a reinforcement package and the tread rubber in a tire.

“Unit tread pressure” means the radial load borne per unit area (square centimeter or square inch) of the tread surface when that area is in the footprint of the normally inflated and normally loaded tire.

“Wedge” refers to a tapered rubber insert, usually used to minimize curvature of a reinforcing component, e.g. at a belt edge.

“Wings” means the radial inward extension of the tread located at axial extremes of the tread, the inner surface of the wing being an extension of the inner casing contacting surface of the tread.

“Year-round” means a full calendar year through each season. For example, a snow tire is not designed for year-round use since it creates objectionable noise on dry road surfaces and is designed to be removed when the danger of snow is passed.

### BRIEF DESCRIPTION OF THE DRAWINGS

The invention will be described by way of example and with reference to the accompanying drawings in which:

FIG. 1 is a schematic perspective view of a tire for use with a structure in accordance with the present invention.

FIG. 2 is a schematic sectional view of the tire of FIG. 1.

FIG. 3 is a schematic detail view of part of the tire of FIG. 1 with the structure under a first condition.

FIG. 4 is a schematic detail view of part of the tire of FIG. 1 with the structure under a second condition.

FIG. 5 is a schematic exploded view of the structure of FIGS. 3 and 4.

### DETAILED DESCRIPTION OF AN EXAMPLE EMBODIMENT OF THE PRESENT INVENTION

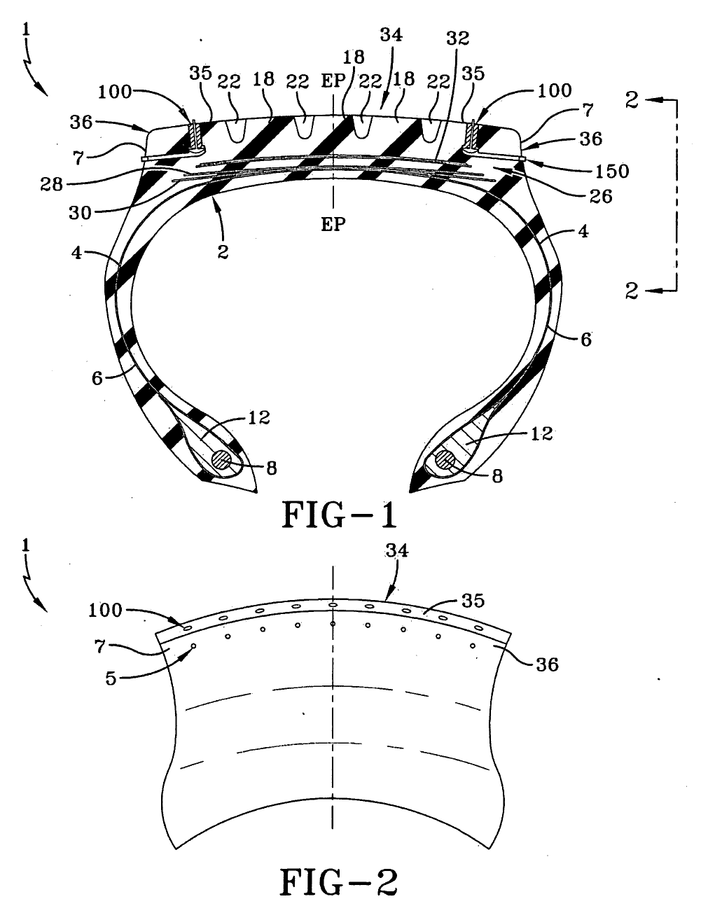

FIG. 1 shows a cross-section of an example tire 1 for use with the present invention. The tire 1 comprises a torus-shaped carcass 2, of the radial or of the cross-ply type, comprising a resistant structure which is formed by at least a rubberized fabric ply 4 reinforced with textile or metal cords and having turnup ends 6 each fixed to a pair of circumferentially unextendable, preferably metallic, annular core, known and referred to hereinbelow as reinforcing bead cores 8. The bead cores 8 are provided with rubber filling apexes 12. The zone of the example tire 1 comprising the bead core 8 and filling apex 12 forms the bead, intended for fixing the tire 1 to a corresponding mounting rim (not shown).

The carcass 2 has arranged on it, in a known manner, a tread band 34 which is intended for the rolling contact of the example tire 1 on the ground and is provided with a raised pattern comprising grooves 22 formed in the thickness of the tread band 34 and define a plurality of blocks and/or ribs 18. The combination of these structural elements, in various configurations, produces different tread patterns which are generally optimized for different applications of the example tire 1.

Together with the carcass 2 of the example tire 1, a belt structure 26 is arranged on the crown of carcass, in between the carcass ply 4 and the tread band 34, axially extending from one side to the other of the example tire, i.e. as wide as the tread band 34. The belt structure 26 may include at least two rubberized fabric strips 28, 30, radially superimposed with textile and/or metallic reinforcing cords parallel to one another in each strip, mutually intersecting with those of the adjacent strip and with respect to the equatorial plane EP of the example tire. The belt structure 26 may also include a radially outermost strip 32 with textile and/or metallic reinforcing cords, oriented at 0 degrees relative to a circumferential direction of the example tire 1.

The thickness of the tread band 34 may be between 8 mm and 24 mm, and more specifically, between 15 mm and 16 mm for passenger tires, between 8 mm and 11 mm for light truck tires, and between 18 mm and 24 mm for medium truck tires. The tread band 34 may be constructed of a compound generally suitable for winter usage, and specifically suited for winter usage with studs. The tread band 34 may have, inserted in it, a plurality of structures 100 in accordance with the present invention.

The structures 100 may provide anti-slip elements for enhanced snow and ice traction. The structures 100 may be received in recesses 3 that secure the structures within the tread band 34. An air channel 5 extends axially from the radially innermost portion of the recess 3 to the outer surface 7 of the lateral side 36 of the tread band 34.

Each structure 100 includes a housing 110, stud portion 130 slidingly secured within the housing, and a sealing element 150 for maintaining air pressure within the air channel 5. The housing 110 has a cylindrical configuration with a central channel 112 for receiving part of the stud portion 130, a cylindrical flange 114 for securing the housing against radially outward movement, and a spring biasing element 116 for biasing part of the stud portion radially inward. The spring biasing element 116 may be constructed of any suitable resilient material, such as rubber or a thermoplastic, such that the stud portion 130 remains in a retracted position and resists the centripetal forces generated upon rotation of the tire 1.

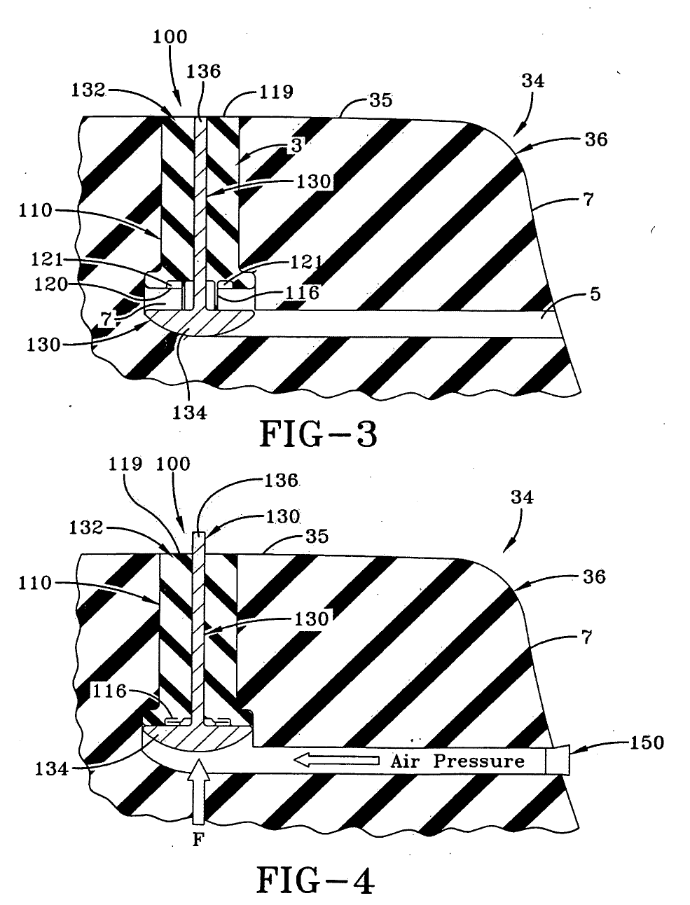

When installed in the tire 1, the housing 110 of each structure 100 is disposed within each recess 3 of the tire 1 with the radially outer surface 118 of the cylindrical flange 114 abutting a shoulder portion 7 of the recess (FIGS. 3 & 4). Also, when installed, a shaft 132 of the stud portion 130 is slidingly disposed within the central channel 112 of the housing 110 and the shaft extends radially inward to a flange 134 of the stud portion 130 located at the intersection of the radially innermost portion of the recess 3 and the axially innermost portion of the air channel 5. The diameter of the recess 3 may be larger than the diameter of the shaft 132 so that the shaft may still slide with the recess when the tread band 34 compresses under the load of a vehicle.

The housing 110 may be constructed of an elastic material similar to the material of the tread band 34 (i.e., a rubber composition) so as to wear as the radially outer surface 35 of the tread band wears. A radially outer surface 119 of the housing 110 may thereby be continually flush with the outer surface 35 of the tread band 34. The stud portion 130 may be constructed of an elastic material suitably hard to grip/penetrate ice, but suitably soft such that a tip 136 of the shaft 132 wears as the radially outer surface 35 of the tread band 34 wears thereby reducing noise, improving handling and comfort, extending functional life of the tire, avoiding road damage (such as damage caused by conventional steel studs). The tip 136 of the shaft 132 may thereby be continually flush with the outer surface 35 of the tread band 34 and the outer surface 119 of the housing 110 when the shaft is in an unextended position (FIG. 3), as described below. The spring biasing element 116 may or may not be constructed of the same material as the housing 110. The housing 110 may alternatively be constructed of an inelastic material with suitable strength and wear properties.

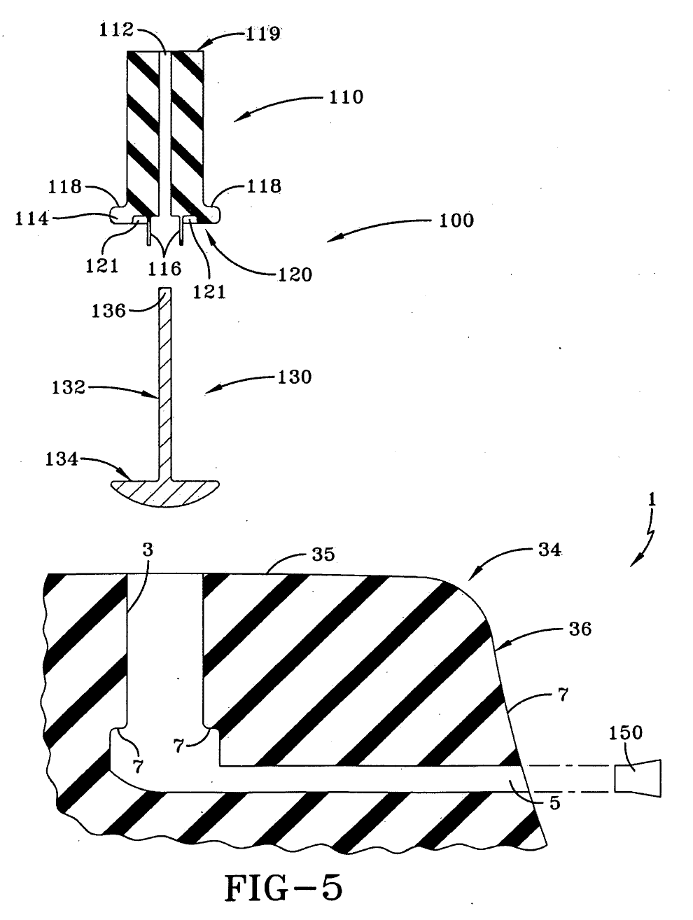

The spring biasing element 116 may or may not be integral to the housing 110. The spring biasing element 116 may or may hot be a complete cylinder circumscribing the shaft 132 of the stud portion 130 or a cylindrical array of projections extending from a radially inner surface 120 of the housing 110. The housing 110 may have a recess 121 disposed at the radially inner surface 120 of the housing 110 for accommodating the spring biasing element 116 in a compressed position (FIG. 4).

During normal, non-winter, non-icy conditions, when ice traction is unneeded, the shaft 132 of the stud portion 130 may be in an unextended position (FIG. 3) with the tip 136 of the shaft 132 flush with the radially outer surface 119 of the housing 110 and the radially outer surface 35 of the tread band 34. When ice traction is needed, a predetermined air pressure (i.e., 29 psi) may be introduced in a suitable manner into the air channel 5. The predetermined air pressure acts on the underside of the flange 134 of the stud portion 130, thereby moving the upper side of the flange radially outward against the spring biasing element 116 of the housing 110. The spring biasing element 116 compresses and allows the flange 134, and thereby the tip 136 of the shaft 132, to move radially outward relative to the housing 110 and the tread band 34. The tip 136 of the shaft 132 may thus extend radially outward beyond the radially outer surface 35 of the tread band 34 and may provide ice traction in a manner similar to conventional studs. The usage of the tip 136 of the structure 100 is thereby occasional, not continual.

When ice traction is no longer needed, the predetermined air pressure may be released from the air channel 5. The spring biasing element 116 may thereby move the flange 134 radially inward and retract the tip 136 of the shaft 132 until ice traction is once more needed. A plug 150 for sealing the air channel 5 is shown at the axially outer portion of the air channel (FIG. 4), but any suitable mechanism may be utilized to selectively seal the predetermined air pressure within the air channel.

One example structure 100 may have a flange 114 of a housing 110 with a diameter of 10.0 mm and a shaft 132 of a stud portion 130 with a diameter of 1.2 mm. The source of the predetermined air pressure may be the tires pressure itself or an external source. As shown in FIG. 5, the structure 100 may be inserted into the recess 3 of the tire 1 with the flanges 114, 134 of the housing 110 and stud portion 130 compressing in the radially outer, relatively narrow portion of the recess and expanding to there original shape when the flanges reach the radially inner, relatively wide portion of the recess. As shown in FIG. 2, the tire 1 may have a plurality of structures 100 as is deemed suitable for ice traction, when required.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A tire comprising:
a carcass;
a tread band having a radially outer tread surface and a plurality of radially extending recesses; and
an anti-slip structure disposed in one of the radially extending recesses, the structure including:
a cylindrical housing with a cylindrical flange and a central channel; and
a stud portion with a shaft and a flange,
the shaft being slidingly disposed within the central channel such that a radially outer tip of the shaft may selectably extend radially outward from the cylindrical housing and from the radially outer tread surface in order to enhance traction for the tire,
the radially outer tip extending from the cylindrical housing and from the radially outer tread surface when a predetermined air pressure is introduced into the radially extending recess thereby forcing the flange of the stud portion radially outward to abut the cylindrical flange of the cylindrical housing.

2. The tire as set forth in claim 1 wherein the cylindrical housing of the structure further includes a radially inner surface, an opposite radially outer surface, and a biasing element extending radially inward from the radially inner surface, the biasing element maintaining the radially outer tip of the stud portion in an unextended position when air pressure in the radially extending recess is less than the predetermined air pressure.

3. The tire as set forth in claim 1 wherein the predetermined air pressure is introduced into the radially extending recess by an axially extending channel.

4. The tire as set forth in claim 3 wherein the axially extending channel interconnects a radially innermost portion of the radially extending recess and an axially outer side portion of the tread band.

5. The tire as set forth in claim 1 wherein the cylindrical housing of the structure further includes a radially inner surface, an opposite radially outer surface, and a biasing element extending radially inward from the radially inner surface, the biasing element compressing into a recess at the radially inner surface when the predetermined air pressure is present in the radially extending recess.

6. The tire as set forth in claim 5 wherein the tire is a pneumatic tire and the predetermined air pressure is supplied by an inflation pressure of the pneumatic tire.

7. The tire as set forth in claim 1 wherein the radially outer tip of the stud portion is flush with an outer surface of the cylindrical housing and the radially outer tread surface when air pressure in the radially extending recess is less than the predetermined air pressure.

8. The tire as set forth in claim 1 wherein the plurality of radially extending recesses each have a shoulder portion for limiting radially outer movement of the flange of the housing.

9. The tire as set forth in claim 8 wherein the flange of the housing limits radially outer movement of the flange of the stud portion.

10. The tire as set forth in claim 1 wherein a sealing element seals the predetermined air pressure within the radially extending recess.
